(19) United States
(12) Patent Application Publication
(10) Pub. No.: US 2026/0245178 A1
(43) Pub. Date: Aug. 20, 2026

(54) IMAGE PROCESSING METHOD, ELECTRONIC DEVICE, AND NON-TRANSITORY COMPUTER-READABLE STORAGE MEDIUM

(71) Applicant: Beijing Zitiao Network Technology Co., Ltd., Beijing (CN)

(72) Inventors: Jiabin HUANG, Beijing (CN); Ying HE, Beijing (CN); Jie CHEN, Beijing (CN); Xinyi ZHANG, Beijing (CN)

(21) Appl. No.: 19/540,425

(22) Filed: Feb. 13, 2026

(30) Foreign Application Priority Data
Feb. 14, 2025 (CN) 202510168502.3

(51) Int. Cl. G06T 5/50; G06T 7/194; G06T 7/90

(52) U.S. Cl. CPC G06T 5/50; G06T 7/194; G06T 7/90

(57) ABSTRACT

An image processing method, an electronic device, and a non-transitory computer-readable storage medium are provided. The method includes: acquiring an original image, where the original image includes a first object; determining first prompt information, a first mask, and second prompt information, where the first prompt information is used for describing an occlusion object occluding the first object, the first mask is used for indicating an occlusion area of the first object by the occlusion object, and the second prompt information is used for describing a second background; and generating a final image based on the original image, the first prompt information, the first mask, and the second prompt information, where the final image includes the occlusion object, the first object, and the second background, and the occlusion object in the final image occludes a first area of the first object.

### CROSS-REFERENCE TO RELATED APPLICATION

This application claims the priority to and benefits of Chinese Patent Application, No. 202510168502.3, which was filed on February 14, 2025. The aforementioned patent application is hereby incorporated by reference in its entirety.

### TECHNICAL FIELD

The present disclosure relates to an image processing method, an electronic device, and a non-transitory computer-readable storage medium.

### BACKGROUND

In the digital age, as a major breakthrough in the field of artificial intelligence, image generation technology has greatly enriched users' content creation experience and brought unprecedented innovation impetus to various industries. At present, people hope to apply these technologies to specific scenarios, for example, in the field of e-commerce, merchants hope to customize product promotion images through the image generation technology.

One of the key operations for customizing product promotion images is background replacement. In the current field of image processing, users may already perform background replacement on input product images. However, the existing background replacement technology has significant limitations. Specifically, an image generated by this technology is usually just a simple superposition of a product on a new background. In the image obtained by this method, the product and the surrounding environment lack effective semantic association and visual fusion effects, and it is difficult to construct a visual effect of interaction between the product and the environment.

### SUMMARY

The embodiments of the present disclosure provides an image processing method, an electronic device, and a non-transitory computer-readable storage medium.

An embodiment of the present disclosure provides an image processing method, including:

acquiring an original image, where the original image includes a first object;

determining first prompt information, a first mask, and second prompt information, where the first prompt information is used for describing an occlusion object occluding the first object, the first mask is used for indicating a first area, the first area is an occlusion area of the first object by the occlusion object, and the second prompt information is used for describing a second background; and

generating a final image based on the original image, the first prompt information, the first mask, and the second prompt information, where the final image includes the occlusion object, the first object, and the second background, and the occlusion object in the final image occludes the first area of the first object.

Another embodiment of the present disclosure further provides an electronic device, including:

one or more processors; and

a storage apparatus, configured to store one or more programs,

where the one or more programs, when executed by the one or more processors, cause the one or more processors to implement the above image processing method.

Yet another embodiment of the present disclosure further provides a non-transitory computer-readable storage medium, where a computer program is stored on the computer-readable storage medium, and the computer program, when executed by a processor, implements the image processing method according to the above.

### BRIEF DESCRIPTION OF DRAWINGS

The drawings herein, which are incorporated in and constitute a part of this specification, illustrate embodiments consistent with the present disclosure and, together with the description, serve to explain the principles of the present disclosure.

In order to more clearly explain the technical solutions in the embodiments of the present disclosure or in the prior art, the drawings required to be used in the description of the embodiments or the prior art will be briefly introduced below. Obviously, for those of ordinary skill in the art, other drawings may also be obtained according to these drawings without paying any creative efforts.

FIG. 1 is a flowchart of an image processing method provided by an embodiment of the present disclosure;

FIG. 2 is a schematic diagram of a display interface of an electronic device provided by an embodiment of the present disclosure;

FIG. 3 is a schematic diagram of an original image provided by an embodiment of the present disclosure;

FIG. 4 is a schematic diagram of a final image obtained based on the original image in FIG. 3;

FIG. 5 is a schematic structural diagram of an image processing apparatus provided by an embodiment of the present disclosure; and

FIG. 6 is a schematic structural diagram of an electronic device provided by an embodiment of the present disclosure.

### DETAILED DESCRIPTION

In order to understand the above objects, features and advantages of the present disclosure more clearly, the solutions of the present disclosure will be further described below. It should be noted that the embodiments of the present disclosure and the features in the embodiments may be combined with each other without conflict.

Many specific details are set forth in the following description to facilitate a full understanding of the present disclosure, but the present disclosure may also be implemented in other ways different from those described herein. Obviously, the described embodiments are part of the embodiments of the present disclosure, but not all of the embodiments.

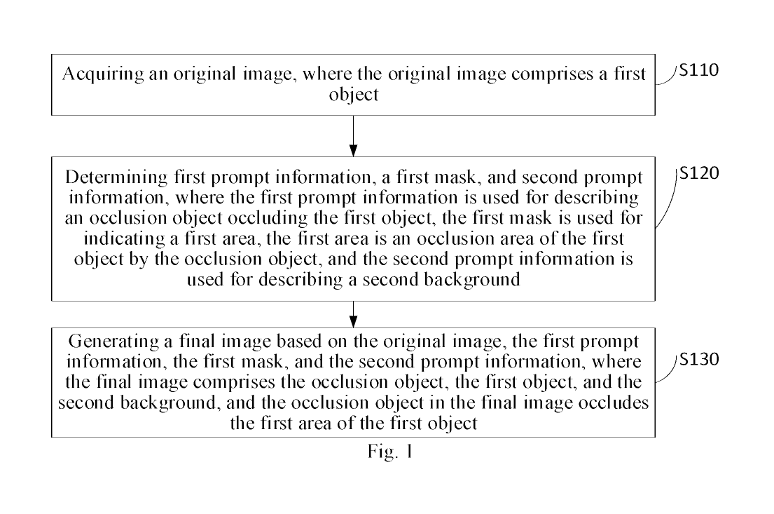

FIG. 1 is a flowchart of an image processing method provided by an embodiment of the present disclosure. The embodiment may be applied to a case where image processing is performed in a client. The method may be executed by an image processing apparatus, and the apparatus may be implemented in a way of software and/or hardware and may be configured in an electronic device, such as a terminal, for example, including but not limited to a smart phone, a palmtop computer, a tablet computer, a wearable device with a display screen, a desktop computer, a laptop computer, an all-in-one computer, a smart home device, and the like. Alternatively, the embodiment may be applied to a case where image processing is performed in a server. The method may be executed by an image processing apparatus, and the apparatus may be implemented in a way of software and/or hardware and may be configured in an electronic device, such as a server.

Compared with the prior art, the technical solutions provided by embodiments of the present disclosure have the following advantages:

The technical solution provided by the embodiment of the present disclosure includes: acquiring an original image, where the original image includes a first object; determining first prompt information, a first mask, and second prompt information, where the first prompt information is used for describing an occlusion object occluding the first object, the first mask is used for indicating a first area, the first area is an occlusion area of the first object by the occlusion object, and the second prompt information is used for describing a second background; and generating a final image based on the original image, the first prompt information, the first mask, and the second prompt information, where the final image includes the occlusion object, the first object, and the second background, and in the final image, the occlusion object occludes the first area of the first object. The technical solution is essentially a method capable of performing background replacement on the original image. After the background replacement is completed, the first object is placed in a new background and occluded by things (that is, the occlusion object) in the new environment. The fact that the first object is occluded by the occlusion object may form an effective semantic association and visual fusion effect between the first object and the surrounding environment, thereby constructing a visual effect of interaction between the first object and the environment.

As shown in FIG. 1, the method may for example include the following steps.

S110: acquiring an original image, where the original image includes a first object.

The original image may be, for example, an image that requires background replacement. In some scenarios, the original image is an image specified or uploaded by a user.

The first object is a thing in the original image, which may be specifically a person, an animal, a plant, a building, an object, or the like. In an e-commerce scenario, the object may be a product.

The original image may include a background or not. If the original image does not include a background, the original image may be a result of performing a matting operation on an image containing the first object and other things. If the original image includes a background (hereinafter referred to as a first background), the first background may be a pure color background or a non-pure color background. The pure color background may be, for example, a pure white background. The non-pure color background may be, for example, a background that contains things capable of creating a specific atmosphere or scene, such as a natural landscape, architectural elements, and the like. These elements may enrich background information of the image and reflect an environment where the first object is located.

S120: determining first prompt information, a first mask, and second prompt information, where the first prompt information is used for describing an occlusion object occluding the first object, the first mask is used for indicating a first area, the first area is an occlusion area of the first object by the occlusion object, and the second prompt information is used for describing a second background, where the second background is different from the first background.

With the technical solution provided by the present application, a finally generated image is a final image. In the final image, the "first object" in the original image is maintained in the final image, and the first background in the original image is replaced with the second background. The final image further includes the occlusion object, and the occlusion object is a person, an animal, a plant, a building, an object, or the like. In the final image, the occlusion object occludes the first object. Here, it should be noted that the occlusion of the first object by the occlusion object is just a manifestation of interaction between the first object and the environment reflected by the second background.

The first prompt information may be, for example, description information for specifying a specific thing for the occlusion object, a color, a shape, a posture, a layout, and the like of the occlusion object. The second prompt information may be, for example, information for describing content of the second background or an environment desired to be created through the second background.

There are multiple specific implementation methods for "determining the first prompt information and the second prompt information", which is not limited in the present application. Exemplarily, in some embodiments, "determining the first prompt information and the second prompt information" may include: displaying an image processing page, where the image processing page includes multiple scene identifications, and the scene identifications are associated with prompt information; and in response to a selection operation for a first scene identification among the multiple scene identifications, using prompt information corresponding to the first scene identification as scene prompt information, where the scene prompt information includes the first prompt information and the second prompt information.

The image processing page may be, for example, a page for performing background replacement on the original image. Through the image processing page, relevant information that may reflect what kind of background the user desires to replace the original image with may be collected.

Each scene identification represents a scene. The scene identification may be, for example, information that distinguishes one scene from other scenes. The scene may be, for example, a specific environment, such as a forest, a bedroom, or a beach.

The scene identification is associated with the prompt information. The prompt information associated with the scene identification is description information for the specific scene represented by the scene identification.

The selection operation for the first scene identification among the multiple scene identifications may be, for example, a selection operation for the first scene identification in the image processing page, which may be specifically a click operation, a slide operation, a hover operation, a drag operation, or the like. The first scene is a scene represented by the first scene identification selected by the user. The user selects the first scene identification, which means that the user desires the generated image to be that the first object is in the first scene.

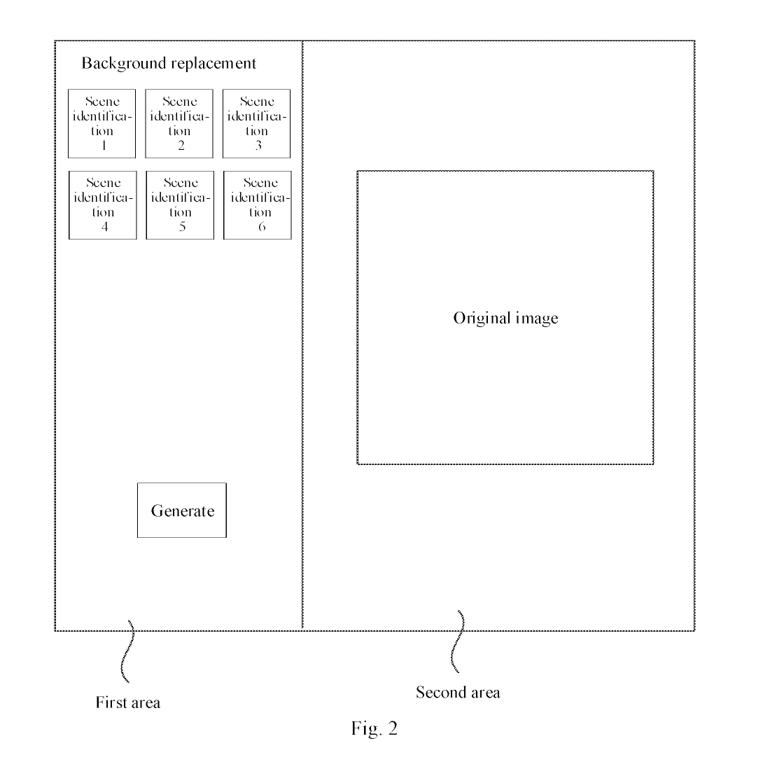

Exemplarily, referring to FIG. 2, the image processing page includes a first page area and a second page area, and the first page area includes multiple scene identifications. The multiple scene identifications include scene identification 1, scene identification 2, scene identification 3, scene identification 4, scene identification 5, and scene identification 6. For example, a scene referred to by the scene identification 1 is a bedroom, and prompt information associated with the scene identification 1 is "The product is placed on the floor of the bedroom with a small and elegant table lamp on it. The soft glow emitted by the lamp casts soft light on the product". For another example, a scene referred to by the scene identification 2 is a beach, and prompt information associated with the scene identification 2 is "The product is carefully placed on the beach where the sand covers some of the bottom of the product, gentle waves lap against the shore, the golden sand stretches to the horizon, and the soft hues of the sky at sunset create a peaceful and warm atmosphere". If the user clicks on the scene identification 1, "The product is placed on the floor of the bedroom with a small and elegant table lamp on it. The soft glow emitted by the lamp casts soft light on the product" is used as the scene prompt information. In the scene prompt information, the "product" refers to the first object. "With a small and elegant table lamp on it. The soft glow emitted by the lamp casts soft light on the product" is the first prompt information, which describes the occlusion object "table lamp". "On the floor of the bedroom" is the second prompt information, which describes an environment or a scene where the "product" is located.

In some other embodiments, "determining the first prompt information and the second prompt information" may include: acquiring scene prompt information input by a user, where the scene prompt information includes the first prompt information and the second prompt information.

There are multiple specific implementation methods for "determining the first mask", which is not limited in the present application. Exemplarily, in an example, optionally, the scene prompt information further includes third prompt information, and the third prompt information is used for describing a position of the first area; and determining the first mask includes: determining the first mask based on the third prompt information. Still take "The product is placed on the floor of the bedroom with a small and elegant table lamp on it. The soft glow emitted by the lamp casts soft light on the product" as the scene prompt information. In the scene prompt information, "The product is placed on the floor of the bedroom with a small and elegant table lamp on it" is the third prompt information, which describes the occlusion area (that is, the first area, which is above the product) of the first object "product" by the occlusion object "table lamp".

In an example, optionally, acquiring a mask library, where the mask library includes multiple masks; and determining the first mask from the mask library based on a preset selection rule.

The mask library may be, for example, a pre-built database including multiple masks. At least one of a shape, a size or a position of an area represented by a different mask in the mask library is different. If a certain mask in the mask library is used as the first mask, it means that the occlusion object performs an occlusion operation on the first object in the area marked by the first mask in the original image.

The preset selection rule may be, for example, a preset selection rule, which is used to select a mask as the first mask from the multiple masks in the mask library. The content specifically included in the preset selection rule is not limited in the present application. Exemplarily, the preset selection rule may include: if the scene prompt information further includes third prompt information, how to determine relevant information of the first mask based on the third prompt information; or how to determine relevant information of the first mask according to a position of the first object in the original image; or how to determine relevant information of the first mask according to a selection result of the user for the mask in the mask library.

S130: generating a final image, based on the original image, the first prompt information, the first mask, and the second prompt information, where the final image includes the occlusion object, the first object, and the second background, and the occlusion object in the final image occludes the first area of the first object.

There are multiple implementation methods for this step, which is not limited in the present application. Exemplarily, the implementation method for this step may include: generating a first image based on the original image and the second prompt information, where the first image includes the first object and the second background, and the first object in the first image is not occluded; determining a second area based on the first mask; and repainting the second area in the first image based on the first prompt information to obtain the final image, where the second area in the final image includes the occlusion object.

Optionally, the first image presents a visual effect that the first object is directly superimposed on a new background, and the first object in the first image is completely exposed and not occluded by any object.

There are multiple specific implementation methods for "generating the first image based on the original image and the second prompt information", which is not limited in the present application. Exemplarily, "generating the first image based on the original image and the second prompt information" includes: determining an exclusive feature of the first object based on the original image; and generating the first image based on the exclusive feature of the first object and the second prompt information.

The exclusive feature of the first object may be, for example, a feature or a characteristic that may be used to uniquely identify a specific first object. These features or characteristics are unique to the specific first object, and even between similar objects, they may be clearly distinguished. If the first object is an animal, the exclusive feature information of the first object may include hair color, spots, stripes, body shape, and the like. If the first object is an item, the exclusive feature information of the first object may include: a shape, a size, a material, a surface texture, and the like. The exclusive feature of the first object in the first image is consistent with the exclusive feature of the first object in the original image.

It should be noted that the features of the first object include the exclusive feature and a general feature. The exclusive feature is a key factor for identifying whether an object is the first object. The general feature is often a feature shared by different objects. Taking the first object being a table as an example, the exclusive feature may be, for example, a unique carving, a special shape of a table leg, or the like. When the table is presented in images with different backgrounds under conditions of different angles, different clarity, different ambient brightness, and the like, the table may still be accurately identified by virtue of these exclusive features. The general feature may be, for example, a basic structure of four table legs supporting a tabletop, a plane characteristic of the tabletop, and the like, which is shared by most tables.

The general feature helps to shape the overall image of the first object, and the exclusive feature is mainly used to improve the recognition of the first object. When the first image is generated, the exclusive feature of the first object is used, which may ensure that the first image includes the first object, or the first object is maintained in the first image.

Optionally, determining an exclusive feature and a general feature of the first object based on the original image; and generating the first image based on the exclusive feature, the general feature of the first object and the second prompt information.

The second area may be, for example, used for indicating a repainting area required in the first image. The purpose of repainting is to form a visual effect that the occlusion object occludes the area of the first object.

Optionally, the second area includes the first area. That is, the first area is located in the second area.

It should be noted that, in practice, in order to enable the image of the second area after repainting to be naturally adjoined with the image of the area that is not repainted, it may be set that the first area is located in the second area, and the area of the second area is larger than that of the first area.

There are multiple specific implementation methods for "determining the second area in the first image based on the first mask", which is not limited in the present application. Exemplarily, "determining the second area in the first image based on the first mask" may include: determining a second mask based on the original image, where the second mask is used for indicating an area occupied by the first object; and determining the second area based on the second mask and the first mask.

The second mask is specifically used for indicating the area occupied by the first object in the original image. In other words, the second mask is used for indicating the area occupied by the first object in the absence of any object occlusion.

By determining the second area based on the second mask and the first mask, it can determine a reasonable second area by considering both the area occupied by the first object in the original image and the expected occlusion area of the first object by the occlusion object when determining the repainting area (that is, the second area), so as to avoid the occurrence of unnatural adjoining between the image of the second area after repainting and the image of the area that is not repainted due to the inaccurate second area.

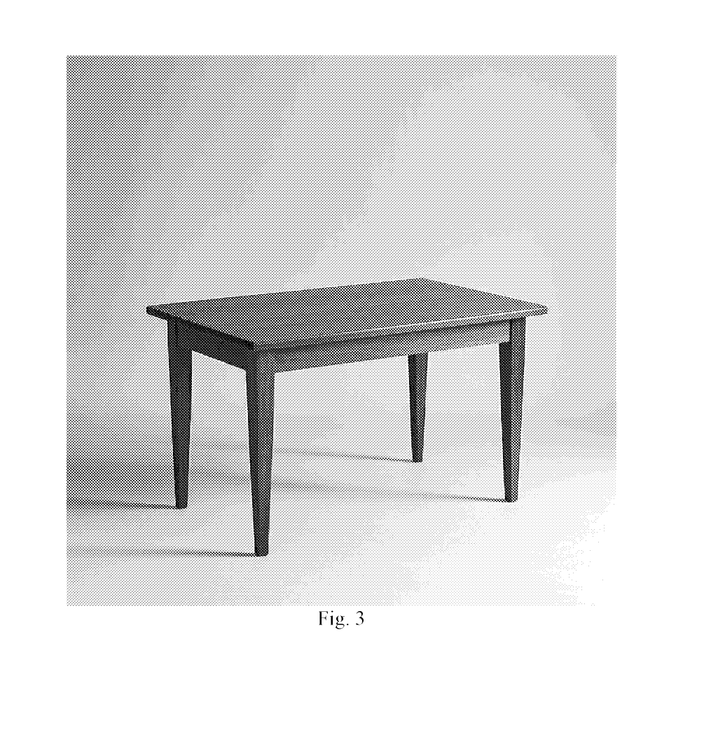

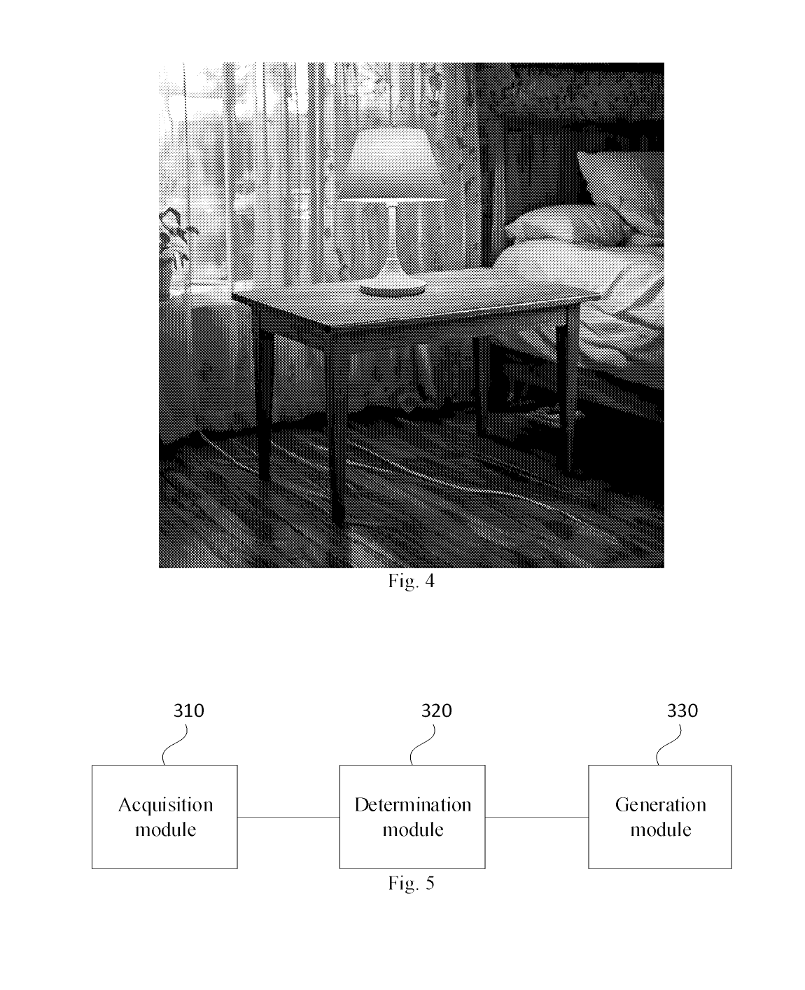

Exemplarily, the image in FIG. 3 is used as the original image, and the first object in the original image is a table. The original image is imported into the image processing page in FIG. 2. If the user clicks on the scene identification 1, the prompt information "The product is placed on the floor of the bedroom with a small and elegant table lamp on it. The soft glow emitted by the lamp casts soft light on the product" associated with the scene identification 1 is used as the scene prompt information. In this example, the "product" refers to the table in FIG. 3. The first prompt information, the first mask, and the second prompt information may be obtained based on the scene prompt information. The final image generated based on the scene prompt information and the original image is shown in FIG. 4. In the final image, the upper surface of the table is occluded by the "table lamp". By comparing FIG. 3 with FIG. 4, the final image is a result of replacing the background of the original image.

The above technical solution includes: acquiring an original image, where the original image includes a first object; determining first prompt information, a first mask, and second prompt information, where the first prompt information is used for describing an occlusion object occluding the first object, the first mask is used for indicating a first area, the first area is an occlusion area of the first object by the occlusion object, and the second prompt information is used for describing a second background, where the second background is different from the first background; and generating a final image based on the original image, the first prompt information, the first mask, and the second prompt information, where the final image includes the occlusion object, the first object, and the second background, and the occlusion object in the final image occludes the first area of the first object. The technical solution is regarded as a method capable of performing background replacement on the original image. After the background replacement is completed, the first object is placed in a new background and occluded by things (that is, the occlusion object) in the new environment. The fact that the first object is occluded by the occlusion object may form an effective semantic association and visual fusion effect between the first object and the surrounding environment, thereby constructing a visual effect of interaction between the first object and the environment.

In practice, with the above technical solution, at least the following scenarios may be implemented: placing the first object in a natural environment, where the first object is occluded by an item located in front of the first object; placing the first object in water (for example, making it float on the water surface), where the first object is occluded by the water or splashed water droplets; or enabling a person or an animal to hold or wear the first object, where the first object is occluded by a hand, clothing, an accessory, or the like.

On the basis of the above technical solution, optionally, S130 may be replaced with: determining negative prompt information; and generating a final image based on the original image, the first prompt information, the first mask, the second prompt information, and the negative prompt information.

The negative prompt information may be, for example, a negative guide phrase input by the user or a preset negative guide phrase. In an image generation model, the negative prompt information is used to guide the image generation model which content should be avoided to be generated, which may make a result of the image generation more controllable.

Optionally, generating the first image based on the exclusive feature of the first object and the second prompt information may include: generating the first image based on the exclusive feature of the first object, the second prompt information, and the negative prompt information.

Optionally, repainting the second area in the first image based on the first prompt information to obtain the final image, where the second area in the final image includes the occlusion object may include: repainting the second area in the first image based on the first prompt information and the negative prompt information to obtain the final image, where the second area in the final image includes the occlusion object.

As an optional but non-limiting implementation, in response to receiving the active request from the user, the prompt information may be sent to the user in a form of, for example, a pop-up window, and the prompt information may be presented in text in the pop-up window. In addition, the pop-up window may further include a selection control for the user to select "agree" or "disagree" to provide the personal information to the electronic device.

It may be understood that the above process of notifying and acquiring user authorization is only illustrative and does not limit the implementations of the present disclosure, and other manners that satisfy the relevant laws and regulations may also be applied to the implementations of the present disclosure.

It should be noted that, for the sake of simple description, the foregoing method embodiments are all expressed as a series of action combinations, but those skilled in the art should know that the present invention is not limited by the described action order, for the reason that according to the present invention, some steps may be performed in other order or simultaneously. Secondly, those skilled in the art should also know that the embodiments described in the specification all belong to preferred embodiments, and the actions and modules involved are not necessarily required by the present invention.

FIG. 5 is a schematic structural diagram of an image processing apparatus provided by an embodiment of the present disclosure. The image processing apparatus provided by the embodiment of the present disclosure may be configured in a client or a server. Referring to FIG. 5, the image processing apparatus for example includes:

an acquisition module 310, configured to acquire an original image, where the original image includes a first object;

a determination module 320, configured to determine first prompt information, a first mask, and second prompt information, where the first prompt information is used for describing an occlusion object occluding the first object, the first mask is used for indicating a first area, the first area is an occlusion area of the first object by the occlusion object, and the second prompt information is used for describing a second background; and

a generation module 330, configured to generate a final image based on the original image, the first prompt information, the first mask, and the second prompt information, where the final image includes the occlusion object, the first object, and the second background, and in the final image, the occlusion object occludes the first area of the first object.

Further, the generation module 330 is configured to:

generate a first image based on the original image and the second prompt information, where the first image includes the first object and the second background, and the first object in the first image is not occluded;

determine a second area based on the first mask; and

repaint the second area in the first image based on the first prompt information to obtain the final image, where the second area in the final image includes the occlusion object.

Further, the generation module 330 is configured to:

determine an exclusive feature of the first object based on the original image; and

generate the first image based on the exclusive feature of the first object and the second prompt information.

Further, the generation module 330 is configured to:

determine a second mask based on the original image, where the second mask is used for indicating an area occupied by the first object; and

determine the second area based on the second mask and the first mask.

Further, the determination module 320 is configured to:

display an image processing page, where the image processing page includes multiple scene identifications, and each scene identification is associated with prompt information; and

in response to a selection operation for a first scene identification among the multiple scene identifications, use prompt information corresponding to the first scene identification as scene prompt information, where the scene prompt information includes the first prompt information and the second prompt information.

Further, the scene prompt information further includes third prompt information, and the third prompt information is used for describing a position of the first area; and the determination module 320 is configured to determine the first mask based on the third prompt information; or,

the determination module 320 is configured to: acquire a mask library, where the mask library includes multiple masks; and determine the first mask from the mask library based on a preset selection rule.

Further, the generation module 330 is configured to:

determine negative prompt information; and

generate a final image based on the original image, the first prompt information, the first mask, the second prompt information, and the negative prompt information.

The image processing apparatus provided by the embodiment of the present disclosure may execute the steps executed by the client or the server in the image processing method provided by the method embodiment of the present disclosure, and has the steps executed and beneficial effects, which are not repeated here.

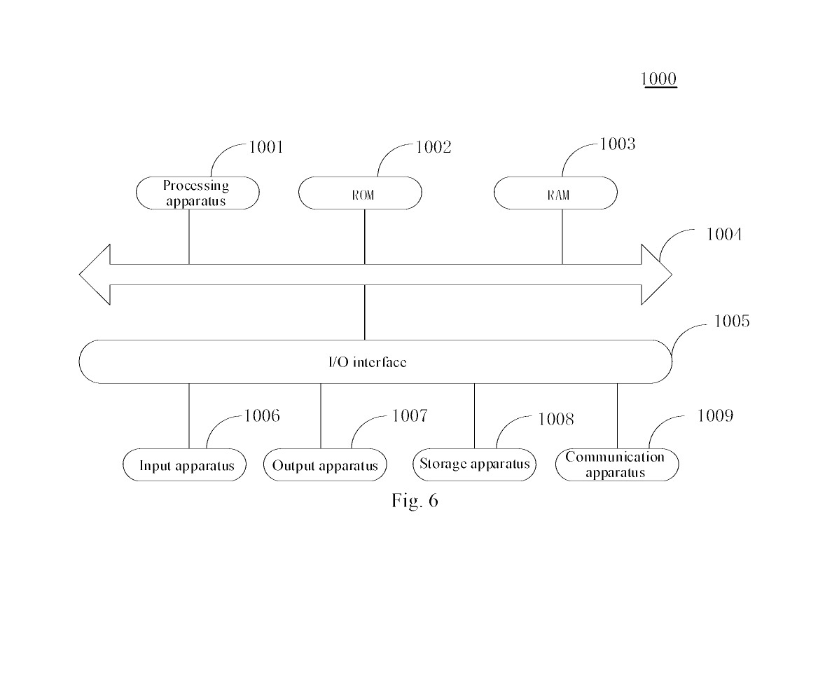

FIG. 6 is a schematic structural diagram of an electronic device provided by an embodiment of the present disclosure. Reference is made specifically to FIG. 6 below, which illustrates a schematic structural diagram of an electronic device 1000 provided by an embodiment of the present disclosure. The electronic device 1000 in the embodiment of the present disclosure may include, but is not limited to, mobile terminals such as a mobile phone, a laptop computer, a digital broadcast receiver, a personal digital assistant (PDA), a tablet computer (PAD), a portable multimedia player (PMP), a vehicle-mounted terminal (e.g., a vehicle navigation terminal), and a wearable electronic device, and fixed terminals such as a digital TV, a desktop computer, and a smart home device. The electronic device shown in FIG. 6 is only an example and should not impose any limitation on the function and the use range of the embodiments of the present disclosure.

As shown in FIG. 6, the electronic device 1000 may include a processing apparatus (e.g., a central processing unit, a graphics processing unit, etc.) 1001 that may perform various appropriate actions and processing according to a program stored in a read-only memory (ROM) 1002 or a program loaded from a storage apparatus 1008 into a random access memory (RAM) 1003 to implement the image processing method of the embodiments according to the present disclosure. The RAM 1003 further stores various programs and information required for operations of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a magnetic tape and a hard disk; and a communication apparatus 1009. The communication apparatus 1009 may allow the electronic device 1000 to perform wireless or wired communication with other devices to exchange information. Although FIG. 6 shows the electronic device 1000 having various apparatuses, it should be understood that it is not required to implement or provide all of the shown apparatuses. Alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program contains program code for executing the method shown in the flowchart, thereby implementing the image processing method as described above. In such an embodiment, the computer program may be downloaded and installed from a network through the communication apparatus 1009, or installed from the storage apparatus 1008, or installed from the ROM 1002. When the computer program is executed by the processing apparatus 1001, the above-mentioned functions defined in the method of the embodiments of the present disclosure are executed.

It should be noted that the above computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, or device, or any suitable combination thereof. More specific examples of the computer-readable storage medium may include, but are not limited to, an electrical connection having one or more conductors, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include an information signal propagated on a baseband or as a part of a carrier wave, and computer-readable program code is carried in the information signal. The information signal propagated in this way may be in multiple forms and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in combination with an instruction execution system, apparatus, or device. The program code contained on the computer-readable medium may be transmitted by any suitable medium, including, but not limited to, a wire, an optical cable, a radio frequency (RF), or any suitable combination thereof.

In some implementations, a client and a server may communicate using any known or future developed network protocol, such as the hypertext transfer protocol (HTTP), and may be interconnected with any form or medium of digital information communication (for example, a communication network). Examples of the communication network include a local area network ("LAN"), a wide area network ("WAN"), an internet (for example, the Internet), a peer-to-peer network (for example, an Ad-Hoc network), and any network known or to be developed in the future.

The above computer-readable medium may be included in the above electronic device or may exist alone without being assembled into the electronic device.

The above computer-readable medium carries one or more programs that, when executed by the electronic device, cause the electronic device to:

acquire an original image, where the original image includes a first object;

determine first prompt information, a first mask, and second prompt information, where the first prompt information is used for describing an occlusion object occluding the first object, the first mask is used for indicating a first area, the first area is an occlusion area of the first object by the occlusion object, and the second prompt information is used for describing a second background, where the second background is different from the first background; and

generate a final image based on the original image, the first prompt information, the first mask, and the second prompt information, where the final image includes the occlusion object, the first object, and the second background, and in the final image, the occlusion object occludes the first area of the first object.

Optionally, when the one or more programs are executed by the electronic device, the electronic device may further perform other steps described in the above embodiments.

The computer program code for performing the operations of the present disclosure may be written in one or more programming languages or a combination thereof, where the programming languages include, but are not limited to, object-oriented programming languages such as Java, Smalltalk, and C++, and further include conventional procedural programming languages such as "C" language or similar programming languages. The program code may be executed entirely on a user computer, partly executed on a user computer, executed as an independent software package, partly executed on a user computer and partly executed on a remote computer, or entirely executed on a remote computer or a server. In the case involving a remote computer, the remote computer may be connected to the user computer through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, a program segment, or a part of code, and the module, the program segment, or the part of code contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments described in the present disclosure may be implemented in a way of software or hardware. Among them, the name of the unit does not constitute a limitation on the unit itself under certain circumstances.

The functions described above herein may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), and the like.

In the context of the present disclosure, a machine-readable medium may be a tangible medium that may contain or store programs for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

According to one or more embodiments of the present disclosure, the present disclosure provides an electronic device, including:

one or more processors; and

a memory, configured to store one or more programs,

where the one or more programs, when executed by the one or more processors, cause the one or more processors to implement the image processing method according to any one provided by the present disclosure.

According to one or more embodiments of the present disclosure, the present disclosure provides a computer-readable storage medium, where a computer program is stored on the computer-readable storage medium, and the computer program, when executed by a processor, implements the image processing method according to any one provided by the present disclosure.

An embodiment of the present disclosure further provides a computer program product, which includes a computer program or instructions, where the computer program or instructions, when executed by a processor, implement the image processing method as described above.

It should be noted that in this paper, relational terms such as "first" and "second" are only used to distinguish one entity or operation from another entity or operation, and do not necessarily require or imply any actual relationship or order between these entities or operations. Moreover, terms "include", "include" or any other variation thereof are intended to cover non-exclusive inclusion, so that a process, method, object or device including a series of elements includes not only those elements, but also other elements not explicitly listed or elements inherent to such process, method, object or device. Without further restrictions, an element defined by a phrase "including a" does not exclude that there are other identical elements in the process, method, object or device including the element.

The above descriptions are only specific implementations of the present disclosure, so that those skilled in the art may understand or implement the present disclosure. Various modifications to these embodiments will be obvious to those skilled in the art, and the general principles defined herein may be implemented in other embodiments without departing from the spirit or scope of the present disclosure. Therefore, the present disclosure will not be limited to these embodiments described herein, but rather to the widest scope consistent with the principles and novel features disclosed herein.

1. An image processing method, comprising:
acquiring an original image, wherein the original image comprises a first object;
determining first prompt information, a first mask, and second prompt information, wherein the first prompt information is used for describing an occlusion object occluding the first object, the first mask is used for indicating a first area, the first area is an occlusion area of the first object by the occlusion object, and the second prompt information is used for describing a second background; and
generating a final image based on the original image, the first prompt information, the first mask, and the second prompt information, wherein the final image comprises the occlusion object, the first object, and the second background, and the occlusion object in the final image occludes the first area of the first object.

2. The method of claim 1, wherein the generating the final image based on the original image, the first prompt information, the first mask, and the second prompt information comprises:
generating a first image based on the original image and the second prompt information, wherein the first image comprises the first object and the second background, and the first object in the first image is not occluded;
determining a second area based on the first mask; and
repainting, based on the first prompt information, the second area in the first image to obtain the final image, wherein the second area comprises the occlusion object.

3. The method of claim 2, wherein the generating the first image based on the original image and the second prompt information comprises:
determining an exclusive feature of the first object based on the original image; and
generating the first image based on the exclusive feature of the first object and the second prompt information.

4. The method of claim 2, wherein the determining the second area in the first image based on the first mask comprises:
determining a second mask based on the original image, wherein the second mask is used for indicating an area occupied by the first object; and
determining the second area based on the second mask and the first mask.

5. The method of claim 2, wherein the determining the first prompt information and the second prompt information comprises:
displaying an image processing page, wherein the image processing page comprises multiple scene identifications, and each scene identification is associated with prompt information; and
in response to a selection operation for a first scene identification among the multiple scene identifications, using prompt information corresponding to the first scene identification as scene prompt information, wherein the scene prompt information comprises the first prompt information and the second prompt information.

6. The method of claim 5, wherein the scene prompt information further comprises third prompt information, and the third prompt information is used for describing a position of the first area; and the determining the first mask comprises:
determining the first mask based on the third prompt information.

7. The method of claim 5, wherein the scene prompt information further comprises third prompt information, and the third prompt information is used for describing a position of the first area; and the determining the first mask comprises:
acquiring a mask library, wherein the mask library comprises multiple masks; and determining the first mask from the mask library based on a preset selection rule.

8. The method of claim 1, wherein the generating the final image based on the original image, the first prompt information, the first mask, and the second prompt information further comprises:
determining negative prompt information; and
generating the final image based on the original image, the first prompt information, the first mask, the second prompt information, and the negative prompt information.

9. An electronic device, comprising:
one or more processors; and
a storage apparatus, configured to store one or more programs,
wherein the one or more programs, when executed by the one or more processors, cause the one or more processors to implement an image processing method,
wherein the image processing method comprises:
acquiring an original image, wherein the original image comprises a first object;
determining first prompt information, a first mask, and second prompt information, wherein the first prompt information is used for describing an occlusion object occluding the first object, the first mask is used for indicating a first area, the first area is an occlusion area of the first object by the occlusion object, and the second prompt information is used for describing a second background; and
generating a final image based on the original image, the first prompt information, the first mask, and the second prompt information, wherein the final image comprises the occlusion object, the first object, and the second background, and the occlusion object in the final image occludes the first area of the first object.

10. The electronic device of claim 9, wherein the generating the final image based on the original image, the first prompt information, the first mask, and the second prompt information comprises:
generating a first image based on the original image and the second prompt information, wherein the first image comprises the first object and the second background, and the first object in the first image is not occluded;
determining a second area based on the first mask; and
repainting, based on the first prompt information, the second area in the first image to obtain the final image, wherein the second area comprises the occlusion object.

11. The electronic device of claim 10, wherein the generating the first image based on the original image and the second prompt information comprises:
determining an exclusive feature of the first object based on the original image; and
generating the first image based on the exclusive feature of the first object and the second prompt information.

12. The electronic device of claim 10, wherein the determining the second area in the first image based on the first mask comprises:
determining a second mask based on the original image, wherein the second mask is used for indicating an area occupied by the first object; and
determining the second area based on the second mask and the first mask.

13. The electronic device of claim 10, wherein the determining the first prompt information and the second prompt information comprises:
displaying an image processing page, wherein the image processing page comprises multiple scene identifications, and each scene identification is associated with prompt information; and
in response to a selection operation for a first scene identification among the multiple scene identifications, using prompt information corresponding to the first scene identification as scene prompt information, wherein the scene prompt information comprises the first prompt information and the second prompt information.

14. The electronic device of claim 13, wherein the scene prompt information further comprises third prompt information, and the third prompt information is used for describing a position of the first area; and the determining the first mask comprises:
determining the first mask based on the third prompt information.

15. The electronic device of claim 13, wherein the scene prompt information further comprises third prompt information, and the third prompt information is used for describing a position of the first area; and the determining the first mask comprises:
acquiring a mask library, wherein the mask library comprises multiple masks; and determining the first mask from the mask library based on a preset selection rule.

16. The electronic device of claim 9, wherein the generating the final image based on the original image, the first prompt information, the first mask, and the second prompt information further comprises:
determining negative prompt information; and
generating the final image based on the original image, the first prompt information, the first mask, the second prompt information, and the negative prompt information.

17. A non-transitory computer-readable storage medium, wherein a computer program is stored on the computer-readable storage medium, and the computer program, when executed by a processor, implements an image processing method,
wherein the image processing method comprises:
acquiring an original image, wherein the original image comprises a first object;
determining first prompt information, a first mask, and second prompt information, wherein the first prompt information is used for describing an occlusion object occluding the first object, the first mask is used for indicating a first area, the first area is an occlusion area of the first object by the occlusion object, and the second prompt information is used for describing a second background; and
generating a final image based on the original image, the first prompt information, the first mask, and the second prompt information, wherein the final image comprises the occlusion object, the first object, and the second background, and the occlusion object in the final image occludes the first area of the first object.

18. The non-transitory computer-readable storage medium of claim 17, wherein the generating the final image based on the original image, the first prompt information, the first mask, and the second prompt information comprises:
generating a first image based on the original image and the second prompt information, wherein the first image comprises the first object and the second background, and the first object in the first image is not occluded;
determining a second area based on the first mask; and
repainting, based on the first prompt information, the second area in the first image to obtain the final image, wherein the second area comprises the occlusion object.

19. The non-transitory computer-readable storage medium of claim 18, wherein the generating the first image based on the original image and the second prompt information comprises:
determining an exclusive feature of the first object based on the original image; and
generating the first image based on the exclusive feature of the first object and the second prompt information.

20. The non-transitory computer-readable storage medium of claim 18, wherein the determining the second area in the first image based on the first mask comprises:
determining a second mask based on the original image, wherein the second mask is used for indicating an area occupied by the first object; and
determining the second area based on the second mask and the first mask.
